(19) United States
(12) Patent Application Publication
(10) Pub. No.: US 2008/0051237 A1
(43) Pub. Date: Feb. 28, 2008

(54) Bicycle rear derailleur

(75) Inventor: Satoshi Shahana, Osaka (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/509,070

(22) Filed: Aug. 24, 2006

(51) Int. Cl. B62M 9/12; F16H 59/00

(52) U.S. Cl. 474/82

(57) ABSTRACT

A bicycle rear derailleur includes a base member, a movable member, a linkage assembly and an axial spacing adjustment structure. The base member includes a mounting axle configured to be attached to a bicycle frame. The movable member includes a chain guide. The linkage assembly is coupled between the base member and the movable member to move the chain guide between a retracted position and an extended position. The axial spacing adjustment structure is disposed on the mounting axle between the base member and the frame. The axial spacing adjustment structure includes a removeable first spacer and a second spacer, the first spacer having a first axial side facing the frame and a second axial side configured and arranged to engage the second spacer.

### BACKGROUND OF THE INVENTION

1. Field of the Invention

This invention generally relates to a bicycle rear derailleur. More specifically, the present invention relates to a bicycle rear derailleur, which includes an axial spacing adjustment structure that facilitates mounting to frames having different thickness at the derailleur mounting plate.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. One component that has been extensively redesigned over the years is the rear derailleur of the bicycle.

Typically, a rear derailleur has a base member and a movable member with a chain guide movably coupled to the base member via a linkage assembly. The base member is attached to the frame of the bicycle. The chain guide is configured to move the chain laterally over a plurality of rear sprockets. A spring typically biases the chain guide to an innermost or outermost position relative to the rear sprockets. A bowden-type control cable with an outer sheath and an inner wire is typically coupled to the rear derailleur and to a conventional shift control device in order to control movement of the chain guide. The outer casing of the control cable is typically received in a recess of the base member, while the inner wire is fixedly coupled to the linkage assembly to move the chain guide against the biasing force of the spring. Thus, the chain guide can be moved laterally by moving the linkage assembly via the inner wire. Pulling the inner wire moves the chain guide against the biasing force of the spring, while releasing the inner wire causes the chain guide to move due to the biasing force of the spring.

The base member is typically coupled to the rear triangle of the frame of the bicycle using a fixing bolt or axle. Some frames have a removable derailleur hanger plate, while other frames have an integral derailleur mounting plate. In either case, it is desirable for the rear derailleur to be mounted at a predetermined position relative to the rear sprockets for optimum performance. While these typical rear derailleurs usually work very well, there are drawbacks with these rear derailleurs.

In particular, in recent years, bicycle frames have been designed with varying thicknesses at the derailleur mounting plate. It is sometimes difficult to properly mount some rear derailleurs in an optimal position relative to some frames due to the varying thickness at the derailleur mounting plate. In other words, if the frame is thicker at the derailleur mounting plate, some rear derailleurs may be positioned further than desired from the largest rear sprocket when mounted to such frames. Alternatively, if the frame is thinner at the derailleur mounting plate, some rear derailleurs may be positioned closer than desired to the largest rear sprocket when mounted to such frames. While it may be possible for limited adjustment of typical rear derailleurs to accommodate minor mounting variations (minor differences in thicknesses of the derailleur mounting plate), sometimes the limited adjustment capability of the rear derailleur is insufficient for some frames. Moreover, even if such limited adjustment is sufficient, performance of the rear derailleur may not be optimal (e.g. shifting performance may not be as smooth and accurate as originally designed) when mounted to some frames. Furthermore, making such adjustments to the rear derailleur can be cumbersome and time consuming.

In view of the above, it will be apparent to those skilled in the art from this disclosure that there exists a need for an improved bicycle rear derailleur. This invention addresses this need in the art as well as other needs, which will become apparent to those skilled in the art from this disclosure.

### SUMMARY OF THE INVENTION

One object of the present invention is to provide a bicycle rear derailleur that moves a chain guide between a plurality of lateral shift positions in a smooth and reliable manner.

Another object of the present invention is to provide a bicycle rear derailleur, which utilizes an axial spacing adjustment structure in order to selectively mount the rear derailleur to at least two different thickness derailleur mounting plates of bicycle frames in an optimal position on each frame.

Another object of the present invention is to provide a bicycle rear derailleur, which is relatively simple and inexpensive to manufacture and assemble.

The foregoing objects can basically be attained by providing a bicycle rear derailleur, which includes a base member, a movable member, a linkage assembly and an axial spacing adjustment structure. The base member includes a mounting axle configured to be attached to a bicycle frame. The movable member includes a chain guide. The linkage assembly is coupled between the base member and the movable member to move the chain guide between a retracted position and an extended position. The axial spacing adjustment structure is disposed on the mounting axle between the base member and the frame. The axial spacing adjustment structure includes a removeable first spacer and a second spacer, the first spacer having a first axial side facing the frame and a second axial side configured and arranged to engage the second spacer.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a side elevational view of a bicycle equipped with a bicycle rear derailleur having an axial spacing adjustment structure in accordance with an embodiment of the present invention;

FIG. 2 is an enlarged, side elevational view of the bicycle rear derailleur illustrated in FIG. 1, with portions of the bicycle removed for the purpose of illustration;

FIG. 3 is a rear elevational view of the rear derailleur illustrated in FIG. 2, with the rear derailleur mounted to a first rear derailleur mounting plate having a first predetermined thickness, and with the chain guide in a retracted position (extended position shown in broken lines);

FIG. 4 is a rear elevational view of the rear derailleur illustrated in FIG. 2, with the rear derailleur mounted to a second rear derailleur mounting plate having a second predetermined thickness, and with the chain guide in a retracted position (extended position shown in broken lines);

FIG. 5 is an enlarged inside elevational view of the base member of the rear derailleur illustrated in FIGS. 1-3, with both spacers mounted on the axle of the base member;

FIG. 6 is an inside, rear perspective view of the base member illustrated in FIG. 5;

FIG. 7 is an enlarged inside elevational view of the base member of the rear derailleur illustrated in FIGS. 1, 2 and 4, with one spacer mounted on the axle of the base member and with one spacer removed;

FIG. 8 is an inside, rear perspective view of the base member illustrated in FIG. 7;

FIG. 9 is an enlarged inside elevational view of the base member of the rear derailleur illustrated in FIGS. 1-4, with both spacers removed from the axle of the base member;

FIG. 10 is an inside, rear perspective view of the base member illustrated in FIG. 9;

FIG. 11 is an exploded elevational view of the axial spacing adjustment structure of the rear derailleur illustrated in FIGS. 1-10;

FIG. 12 is an exploded, perspective view of the axial spacing adjustment structure of the rear derailleur illustrated in FIGS. 1-10;

FIG. 13 is an enlarged cross-sectional view the axial spacing adjustment structure of the rear derailleur illustrated in FIGS. 1-10, as seen along section line 13-13 of FIG. 5;

FIG. 14 is an inside elevational view of a first spacer of the axial spacing adjustment structure illustrated in FIGS. 1-13; and

FIG. 15 is an inside elevational view of a second spacer of the axial spacing adjustment structure illustrated in FIGS. 1-13.

### DETAILED DESCRIPTION OF THE PREFERRED EMBODIMENTS

A selected embodiment of the present invention will now be explained with reference to the drawings. It will be apparent to those skilled in the art from this disclosure that the following descriptions of the embodiment of the present invention are provided for illustration only and not for the purpose of limiting the invention as defined by the appended claims and their equivalents.

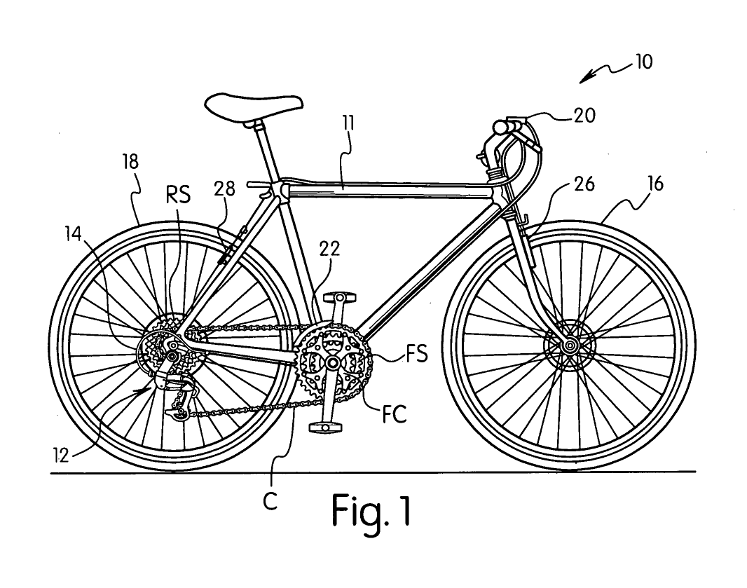

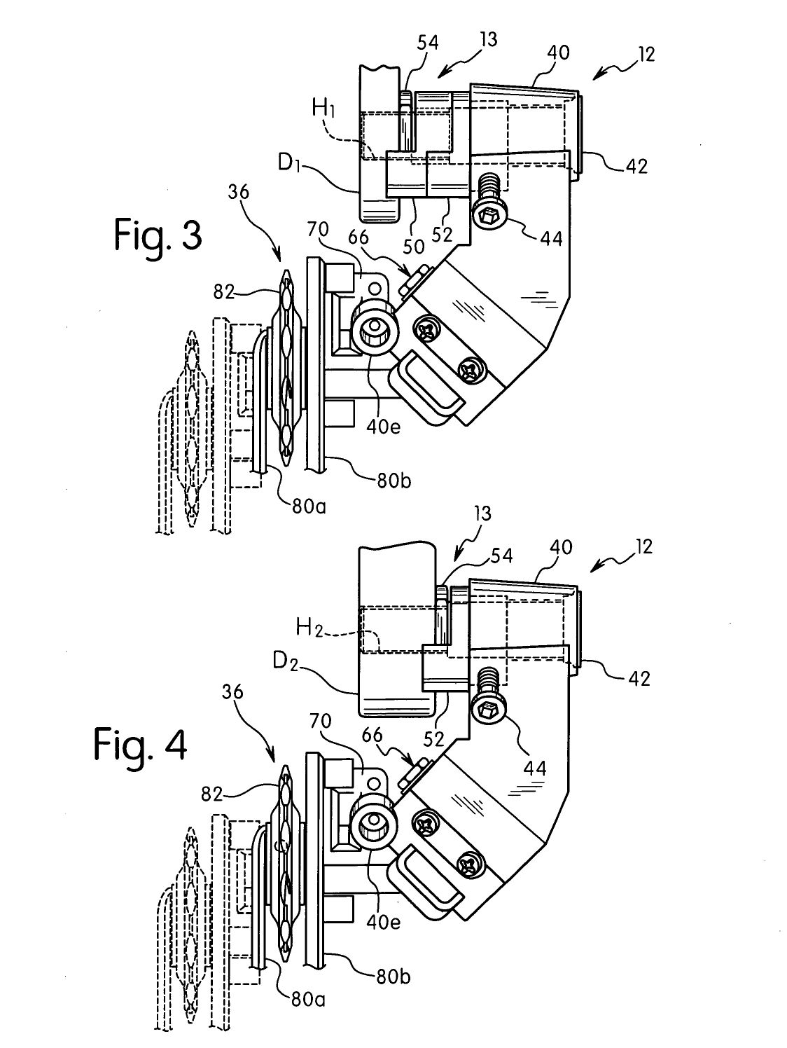

Referring initially to FIGS. 1-4, a bicycle 10 is illustrated with a bicycle rear derailleur 12 coupled thereto in accordance with an embodiment of the present invention. The rear derailleur 12 is designed to be mounted to at least two different derailleur mounting portions or plates D₁ and D₂ of a bicycle frame 11, as seen in FIGS. 3 and 4. Specifically, the rear derailleur 12 includes an axial spacing adjustment structure 13 in accordance with the present invention, which facilitates mounting the rear derailleur 12 to the two different derailleur mounting portions or plates D₁ and D₂, which have different thicknesses. More specifically, the axial spacing adjustment structure 13 preferably includes a removable first spacer 50 and a second spacer 52 in order to facilitate mounting the rear derailleur 12 to the derailleur mounting portions D₁ and D₂, as explained below in more detail.

The bicycle 10 is conventional, except for the rear derailleur 12 having the axial spacing adjustment structure 13. Thus, the bicycle 10 will not be discussed and/or illustrated in detail herein, except as related to the rear derailleur 12. The bicycle 10 basically includes the frame 11 with front and rear wheels 16 and 18 coupled to the frame 11 in a conventional manner. The frame 11 includes a front fork pivotally coupled thereto with a handle bar coupled to the front fork in a conventional manner to steer the front wheel 16. The rear wheel 18 is coupled to the rear triangle of the frame 11. The right side of the rear triangle of the frame 11 has the derailleur mounting portion or plate (i.e., derailleur hanger) D₁ or D₂ fixedly attached thereto depending on the strength/weight characteristics desired for the bicycle 10.

The derailleur mounting portions or plates D₁ and D₂ can be integrally formed with the rear triangle of the frame 11 as illustrated herein, or can be removable type derailleur hangers (not shown) in a conventional manner. In the illustrated embodiment, the derailleur mounting portion D₁ has a thickness of about 8.0 millimeters, while the derailleur mounting portion D₂ has a thickness of about 16.0 millimeters. These are relatively common dimensions for derailleur mounting portions in the bicycle art. The axial spacing adjustment structure 13 of the present invention illustrated herein is dimensioned to be optimally applied to the derailleur mounting portions D₁ and D₂ dimensioned as disclosed herein. However, it will be apparent to those skilled in the art from this disclosure that the present invention can be applied to other frames/thicknesses as needed and/or desired.

Referring still to FIGS. 1-4, the bicycle 10 includes a rear shift control device 20 mounted on the handlebar to control the rear derailleur 12 via a shift control cable 14 in a relatively conventional manner to move a chain C laterally over a plurality of rear sprockets RS that are coupled to the rear wheel 18. The shift control cable 14 includes an inner wire 14a and an outer casing 14b in a conventional manner. The rear sprockets RS are coupled to the rear wheel 18 via a free wheel (not shown) to selectively rotate the rear wheel 18 via the chain C in order to propel the bicycle 10 in a conventional manner. Specifically, a front crank FC with a plurality of front sprockets FS coupled thereto is mounted to the bottom bracket of the frame 11 to cycle the chain C in response to pedaling by the rider, and thus, to propel the bicycle 10 using the rear sprockets RS in a conventional manner. Preferably, a front derailleur 22 with a front shift control cable (not shown) coupled thereto is mounted to the frame 11 in order to shift the chain C laterally over the front sprockets FS in a conventional manner.

Front and rear brake mechanisms 26 and 28 are coupled to the frame 11 in order to apply braking forces to the rims of the front and rear wheels 16 and 18, respectively, in a conventional manner. A front shift control mechanism (not shown) is also preferably coupled to the handlebar to control the front derailleur 22 to shift the chain C laterally over the front sprockets FS in a conventional manner. The rear shift control mechanism 20 preferably includes a brake lever pivotally coupled thereto to control the rear brake mechanism 28 in a conventional manner. The front shift control mechanism (not shown) also preferably includes a brake lever pivotally coupled thereto to control the front brake mechanism 26 in a conventional manner.

Since the various parts of the bicycle 10 are conventional, except for the rear derailleur 12, the parts of the bicycle 10 will not be discussed or illustrated in detail herein, except as they relate to the rear derailleur 12. Moreover, it will be apparent to those skilled in the art from this disclosure that various modifications can be made to the various components or parts of the bicycle 10 without departing from the scope of the present invention.

Referring still to FIGS. 1-4, the rear derailleur 12 basically includes a base member 30, a movable member 32, a linkage assembly 34, a chain guide 36, a biasing member or spring 38 and the axial spacing adjustment structure 13. Generally, the base member 30 is fixedly coupled to frame 11 for limited rotational movement, while the movable member 32 is movably coupled to the base member 30 via the linkage assembly 34 to move the chain guide 36 between an extended position and a retracted position, as best understood from FIGS. 3 and 4. The chain guide 36 is pivotally coupled to the movable member 32. The biasing member or spring 38 normally biases the chain guide 36 to the outer most (smallest) of the rear sprockets RS in a conventional manner. The axial spacing adjustment structure 13 is coupled to the base member 30 to selectively attach the base member 30 to the derailleur mounting portions D₁ and D₂.

The basic operation of the rear derailleur 12 is well known in the prior art. Thus, the rear derailleur 12 will not be discussed or illustrated in detail herein, except as related to the present invention. In other words, this disclosure will focus mainly on the axial spacing adjustment structure 13 of the present invention as well as other elements of the rear derailleur 12 related thereto. While a mechanical (i.e., cable actuated) derailleur 12 is illustrated, it will be apparent to those skilled in the art from this disclosure that the present invention can be employed in other types of derailleurs such as pneumatic derailleurs, motorized/electrical derailleurs or electromechanical derailleurs.

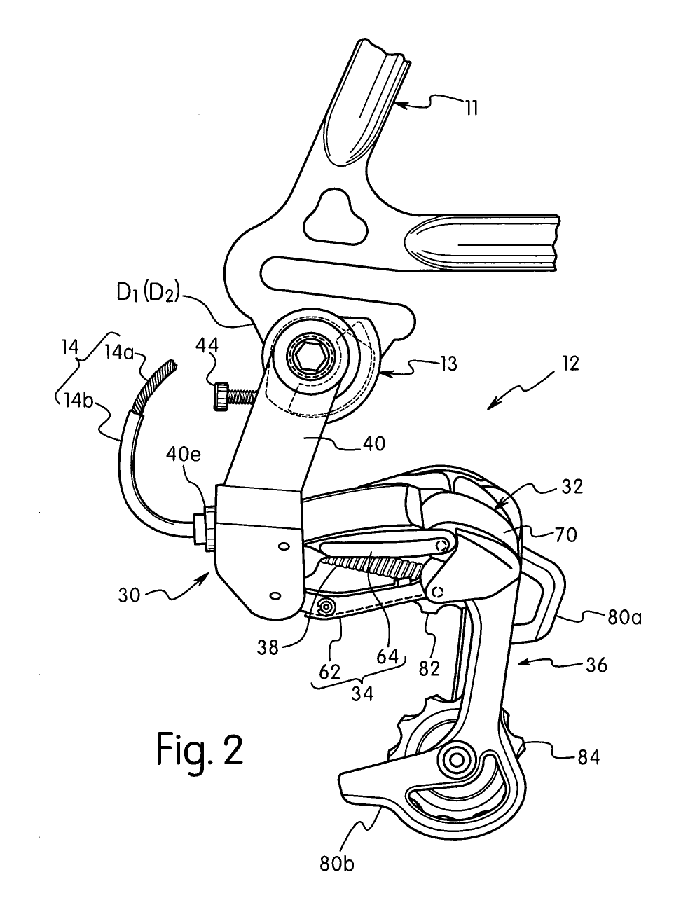

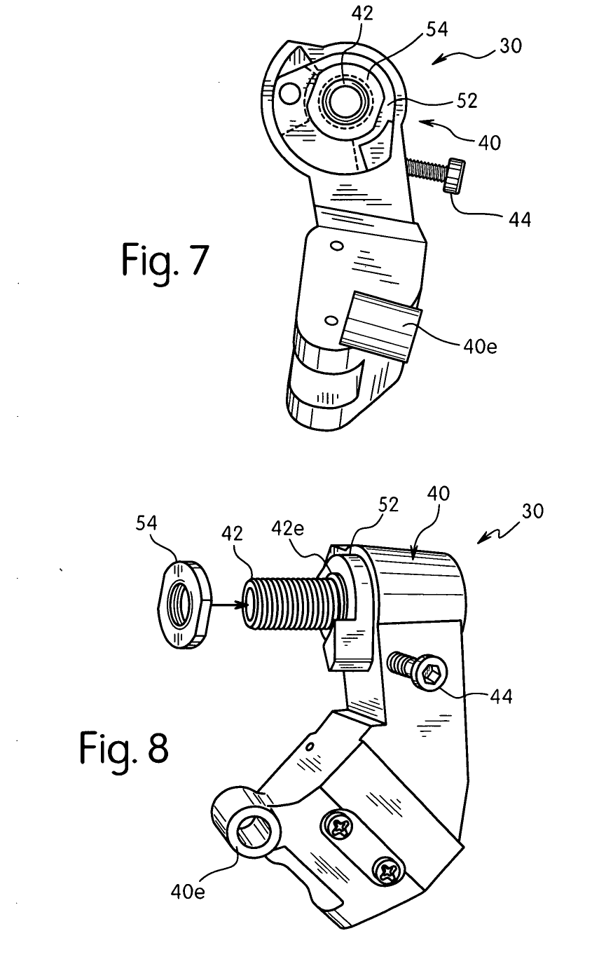

Referring now to FIGS. 2-10, the base member 30 basically includes a base housing 40 and a first horizontal pivot shaft or mounting axle 42. The base housing is preferably constructed as a one-piece, unitary member from a lightweight, rigid material such as a metallic material that is well known in the bicycle art. Similarly, the mounting axle 42 is preferably constructed as a one-piece, unitary member from a lightweight, rigid material such as a metallic material that is well known in the bicycle art. The base housing 40 is pivotally supported on the mounting axle 42. The mounting axle 42 is fixedly attached to the derailleur mounting portion D₁ or D₂. The axial spacing adjustment structure 13 is disposed on the mounting axle 42 to facilitate mounting the rear derailleur to the derailleur mounting portion D₁ or D₂, as explained below. In the illustrated embodiment, the base member does not include a biasing member coupled between the base housing 40 and the derailleur mounting portion D₁ or D₂ to apply a rotational biasing force to the base housing 40. Thus, the base member 30 is not rotationally biased relative to the frame by a biasing member.

The base housing 40 includes a mounting surface 40a, an arc-shaped cutout or recess 40b, a mounting hole 40c, a threaded adjustment hole 40d and a tubular cable mounting portion 40e. The mounting surface 40a is disposed adjacent the axial spacing adjustment structure 13. The mounting hole 40c is a through hole extending generally perpendicularly relative to the mounting surface 40a. The mounting axle 42 extends through the mounting hole 40c. The arc-shaped recess 40b extends axially (parallel to the mounting hole 40c) from the mounting surface 40a. The arc-shaped recess 40b is arced about the mounting hole 40c. The threaded adjustment hole 40d extends between the recess 40b and an external surface of the base housing 40. The cable mounting portion 40e includes a sheath receiving space configured to receive the outer casing 14b therein and the inner wire 14a received therethrough in a conventional manner.

The threaded adjustment hole 40d threadedly receives an adjustment screw 44 therein. The recess 40b receives a bumper element 46, an adjustment plate 48 as well as part of the axial spacing adjustment structure 13 therein. The adjustment screw 44, the bumper element 46, and the adjustment plate 48 as well as the base housing 40 and parts of the axial spacing adjustment structure 13 form parts of a rotational adjustment structure or rotational movement control structure of the rear derailleur 12 in accordance with the present invention. In particular, the position of the adjustment screw 44 can be adjusted to set a rest position of the base member 30 relative to the frame 11 and also to control the amount of rotational movement of the base member 30 relative to the derailleur mounting portion D₁ or D₂, as explained below.

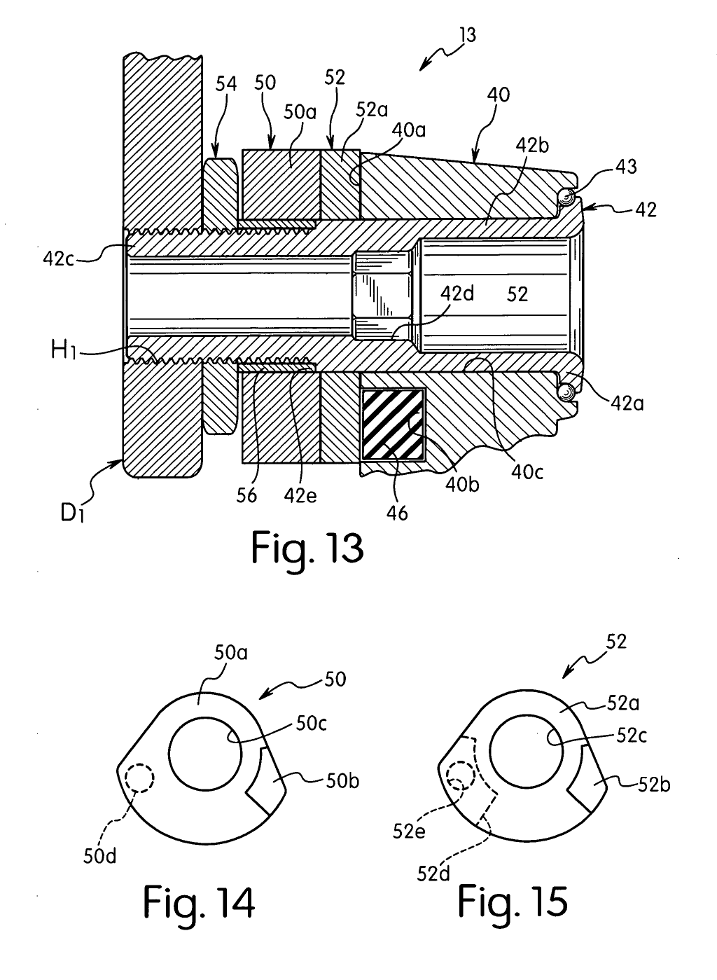

The mounting axle 42 is a relatively conventional hollow mounting shaft. Thus, the mounting axle 42 includes an enlarged head portion 42a, an unthreaded portion 42b, a threaded portion 42c and an internal hexagonal bore section 42d, as best seen in FIGS. 11-13. Preferably, the threaded portion 42c has a smaller outer diameter than the unthreaded portion 42b to form an annular abutment 42e therebetween. The unthreaded portion 42b extends through mounting hole 40c of the base housing 40 to project outwardly from the mounting surface 40a of the base housing 40. A bearing 43 is preferably located between the enlarged head portion 42a and the base housing 40 to facilitate easy rotation of the base housing 40 relative to the mounting axle 42 in a conventional manner, as shown in FIG. 13. Thus, the base housing 40 is freely rotatably mounted on the mounting axle 42. However, the base housing 40 is not freely rotatable relative to the derailleur mounting portions D₁ or D₂ due to the configuration of the rotational adjustment structure of the rear derailleur 12, which is explained below.

Referring now to FIGS. 3-15, the axial spacing adjustment structure 13 will now be explained in more detail. The axial spacing adjustment structure 13 basically includes the removable first spacer 50, the second spacer 52 and a lock nut 54. The second spacer 52 is disposed on the unthreaded portion 42b of the mounting axle 42 (projecting beyond the mounting surface 40a). The first spacer 50 is disposed on the threaded portion 42c of the mounting axle 42 adjacent the second spacer 52. In other words, the second spacer 52 is mounted between the first spacer 50 and the base housing 40 of the base member 30. The first spacer 50 is only used when the rear derailleur 12 is mounted to the relatively thinner derailleur mounting portion D₁. Thus, the removable first spacer 50 is optionally or selectively mounted on the mounting axle 42. On the other hand, the second spacer 52 is disposed on the mounting axle 42 regardless of whether the rear derailleur 12 is mounted to the derailleur mounting portion D₁ or D₂.

The lock nut 54 is disposed on the mounting axle 42 regardless of whether the rear derailleur 12 is mounted to the derailleur mounting portion D₁ or D₂, as best understood from FIGS. 3-8. The lock nut 54 retains the first and second spacers 50 and 52 on the mounting axle 42 when mounting the rear derailleur 12 to the derailleur mounting portion D₁. On the other hand, the lock nut 54 retains only the second spacer 52 on the mounting axle 42 when mounting the rear derailleur 12 to the derailleur mounting portion D₂. In either case, the lock nut 54 is configured and arranged to contact the derailleur mounting portion D₁ or D₂ when the mounting axle 42 is tightened to act as a locking nut to prevent accidental loosening of the mounting axle once tightened.

The derailleur mounting portions D₁ and D₂ have threaded mounting holes HI and H₂ formed therein, respectively, which threadedly receive the threaded portion 42c of the mounting axle 42. In other words, the lock nut 54 is a conventional nut with a non-circular external shape that acts as a locking nut in a relatively conventional manner when the mounting axle 42 is tightened in the threaded mounting hole H₁ or H₂. While the lock nut 54 is illustrated removed from the mounting axle 42 in FIGS. 6 and 8, this is done merely for illustration. When assembled, the lock nut 54 is rotated (threaded) onto the mounting axle 42 such that it is located adjacent the first or second spacer as shown in FIGS. 3 and 4.

The first spacer 50 is preferably rotatably supported on the threaded portion 42c of the mounting axle 42 via a sleeve 56. The second spacer is rotatably supported on the unthreaded portion 42b of the mounting axle. The sleeve 56 is a tubular member with an external diameter corresponding to the external diameter of the unthreaded portion 42b of the mounting axle 42, and an inner diameter substantially identical to or only slightly larger than the outer thread diameter of the threaded portion 42c. The sleeve 56 is designed to be removed from the mounting axle 42 when the first spacer 50 is removed for mounting the rear derailleur 12 to the derailleur mounting portion D₂. However, when the sleeve 56 is mounted on the mounting axle 42, the outer surface of the sleeve 56 forms a continuous support surface together with the unthreaded portion 42b of the mounting axle 42.

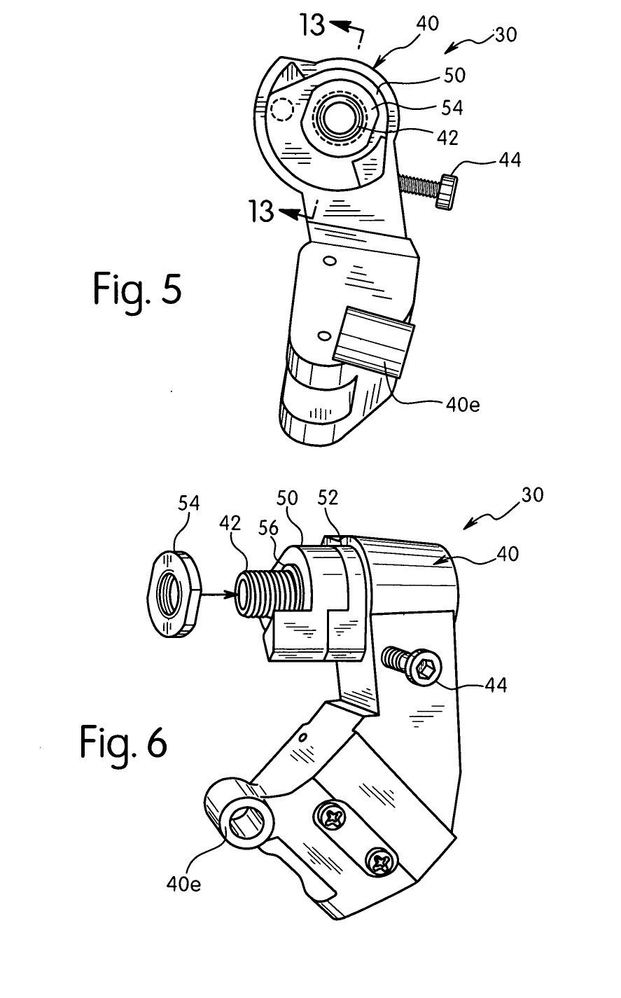

When the sleeve 56 and the first spacer 50 are mounted on the mounting axle 42, the sleeve contacts the abutment 42e of the mounting axle 42 such that the sleeve 56 projects slightly beyond an axially facing surface of the first spacer 50. Thus, the lock nut 54 will contact the sleeve 56 when the sleeve 56 and the first spacer 50 are mounted on the mounting axle 42. The abutment 42e is arranged to project slightly beyond the second spacer 52 to facilitate this arrangement, and to provide a contact point for the lock nut 54 when the sleeve 56 and the first spacer 50 are removed from the mounting axle 42. Due to this arrangement, both the first and second spacers 50 and 52 (or the second spacer 52 alone) can be freely rotatably supported on the mounting axle 42 because the lock nut 54 will not apply an axial force thereto. These arrangements are best understood from FIGS. 5-8 and 13.

The first spacer 50 basically includes a first spacing portion 50a, a first frame contact projection 50b, a first support hole 50c, a first engagement projection 50d and a cutout 50e. Similarly, the second spacer 52 basically includes a second spacing portion 52a, a second frame contact projection 52b, a second support hole 52c and a second engagement projection or movement control projection 52d. In the illustrated embodiment, the first and second spacers 50 and 52 are each preferably constructed as a one-piece, unitary member from a lightweight, rigid material such as a metallic material that is well known in the bicycle art.

The first spacing portion 50a is an eccentrically shaped annular disc with the first support hole 50c extending between oppositely facing axial sides thereof. The first frame contact projection 50b extends from one axial side of the first spacing portion 50a, while the first engagement projection 50d extends from an opposite axial side of the first spacing portion 50a. The first frame contact projection 50b is circumferentially offset from the first engagement projection 50d. The cutout 50e is aligned with the first frame contact projection 50b, and extends into the first spacing portion 50a from the axial side of the first spacing portion 50a facing the second spacer 52.

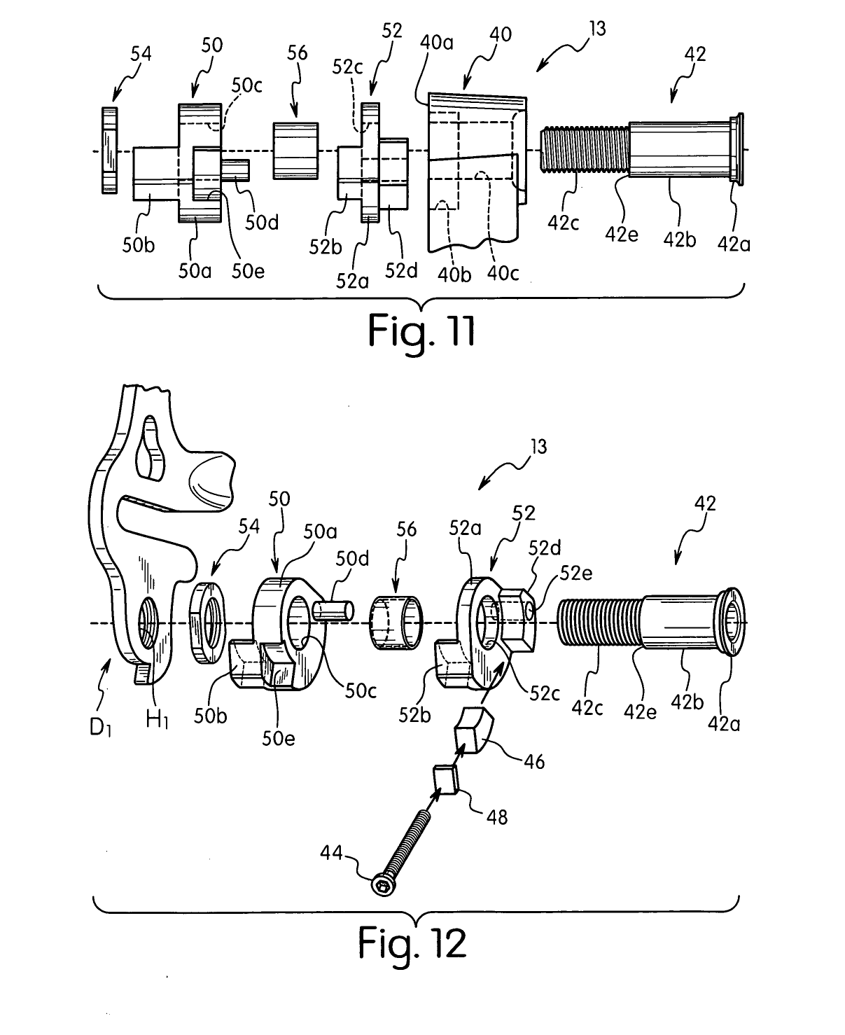

The first spacing portion 50a preferably has an axial thickness corresponding to the difference in thickness between the derailleur mounting portions D₁ and D₂, i.e., about 8.0 millimeters in the illustrated embodiment. The first frame contact projection 50b is configured to cooperate with the outer surface of the derailleur mounting portion D₁ to control movement of the first spacer 50 relative to the derailleur mounting portion D₁ as best understood from FIG. 12. The first engagement projection 50d is configured and arranged to non-rotatably engage the second spacer 52.

The second spacer 52 is similar to the first spacer 50. Thus, the second spacing portion 52a is an eccentrically shaped annular disc with the second support hole 52c extending between oppositely facing axial sides thereof. The second frame contact projection 52b extends from one axial side of the second spacing portion 52a, while the second engagement projection 52d extends from an opposite axial side of the second spacing portion 52a. The second frame contact projection 52b is circumferentially offset from the second engagement projection 52d. The second frame contact projection 52b has a shape and size substantially identical to the first frame contact projection 50b. The cutout 50e has a shape that mates with the second frame contact projection 52b such that the second frame contact projection 52b is received in the cutout 50e when the first spacer 50 is disposed on the mounting axle 42. Thus, the first and second spacing portions 50a and 52a preferably contact each other when mounted on the mounting axle 42 in an assembled state as best understood from FIGS. 3, 5, 6 and 13.

The second spacing portion 52a preferably has an axial thickness smaller than the thickness of the first spacing portion 50a (e.g. about one half as thick) in the illustrated embodiment. The second frame contact projection 52b is configured to cooperate with the outer surface of the derailleur mounting portion D₂ to control movement of the second spacer 52 relative to the derailleur mounting portion D₂ (i.e. when the first spacer 50 and the sleeve 56 are removed), as best understood from FIGS. 4, 8 and 12. An engagement bore 52e extends through the second spacing portion 52a and the second engagement projection 52d. The engagement bore 52e has a size and shape that mates with the first engagement projection 50d in order to non-rotatably coupled the first and second spacers 50 and 52 together in the assembled state, and when the first spacer 50 is mounted on the mounting axle 42 (i.e. to mount the rear derailleur 12 to the derailleur mounting portion D₁.

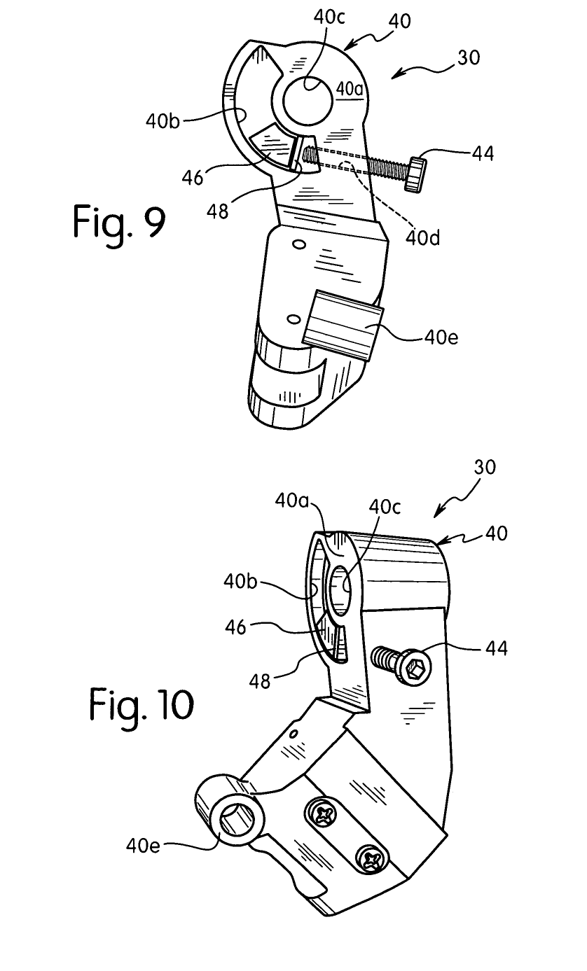

The second engagement projection 52d is configured and arranged to be received in the arc-shaped cutout or recess 40b of the base housing 40. In particular, the second engagement projection 52d is positioned in an area of the recess 40b remote from the free end of the adjustment screw 44. The second engagement projection 52d has a generally arc shape that corresponds to the shape of the recess 40b, except that the second engagement projection 52d is circumferentially shorter than the arc-shaped recess 40b. The bumper element 46 and the adjustment plate 48 are received in the recess 40b circumferentially between the second engagement projection 52d and the free end of the adjustment screw 44, as best seen in FIGS. 9 and 10. The bumper element 46 is constructed of a resilient material such as rubber, while the adjustment plate 48 is constructed of a lightweight, rigid material such as a metallic material that is well known in the bicycle art.

The bumper element 46 is circumferentially arranged between the second engagement projection 52d and the adjustment plate 48. Thus, the adjustment plate 48 is circumferentially arranged between the free end of the adjustment screw 44 and the bumper element 46. The position of the adjustment screw 44 can be adjusted to adjust the effective length of the arc-shaped recess 40b, and thus, the amount of rotational movement of the base housing 40 relative to the second spacer 52. Specifically, if the position of the adjustment screw 44 is adjusted (by rotation in the threaded adjustment hole 40d), the position of the adjustment plate 48 and the bumper element 46 are also adjusted, and thus, the amount of movement of the second engagement projection 52d within the arc-shaped recess 40b can also be adjusted. Accordingly, these parts of the rear derailleur 12 can be considered parts of the rotational adjustment structure in accordance with the present invention.

Of course, the first spacer 50 is also indirectly engaged with the adjustment screw 44 via the second spacer 52, when the first spacer 50 is mounted on the mounting axle 42 in an assembled state. Moreover, the first spacer 50 or the second spacer 52 also cooperates with the derailleur mounting portion D₁ or D₂ and the tension from the chain C to control the positions of the spacers 50 and 52 in a manner similar to the way conventional rear derailleur base members cooperate with the frame and chain tension. Accordingly, these other parts may also be considered parts of the rotational adjustment structure or movement control structure of the base member 30 in accordance with the present invention.

The linkage assembly 34 basically includes a pair of links 62 and 64 that are pivotally coupled at first ends to the base member 30 and pivotally coupled at their other ends to the movable member 32. Four pins (not shown) are used to pivotally couple the links 62 and 64 to the base member 30 and the movable member 32 in a conventional manner. The biasing member 38 (i.e., a coil spring) is coupled between the links 62 and 64 for biasing the chain guide 36 in one direction as best seen in FIG. 2, while the inner wire 14a moves the chain guide 36 in the other direction to locate the chain guide 36 in the correct gear position in a conventional manner. In the illustrated embodiment, the link 62 is an inner link that is located closer to the center plane of the bicycle 10 than the (outer) link 64. The links 62 and 64 are inclined relative to the center plane of the bicycle 10.

A control cable fixing device 66 is coupled to a substantially upper side of the linkage assembly 34 to move the chain guide 36 against the biasing force of the spring 38. Specifically, the control cable fixing device 66 is preferably coupled to an upwardly/inwardly facing surface of the outer/upper link 64. Accordingly, when the rider operates the rear shift control mechanism 20 to pull the inner wire 14a of the shift control cable 14, this will cause links 62 and 64 to pivot inwardly relative to the base member 30 against the bias of the coil spring 38 and will cause the movable member 32 and the chain guide 36 to move inwardly toward the center of the bicycle 10. This in turn will cause the chain C to move from an outer (smaller) gear of the sprockets RS to the next inner (larger) gear of the sprockets RS in a conventional manner. Of course, if the rear shift control mechanism 20 is moved to release the inner wire 14a of the shift cable 14, the spring 38 will move the linkage members 62 and 64 such that the chain guide 36 will move the chain C outwardly from a larger (inner) gear to a smaller (outer) gear in a conventional manner. Of course, it will be apparent to those skilled in the art from this disclosure that thee biasing direction of the spring 38 and the pulling direction of the inner wire 14a could be reversed in needed and/.or desired.

The movable member 32 basically includes a movable housing 70 and a support shaft or axle (not shown) having the chain guide 36 pivotally mounted thereon in a conventional manner. Preferably a torsion spring (not shown) is disposed within the movable housing 70 to apply a rotational biasing force to the chain guide 36 relative to the movable member 32. The chain guide 36 basically has a pair of guide plates 80a and 80b with a guide sprocket or pulley 82 rotatably coupled between the guide plates 80a and 80b and a tension sprocket or pulley 84 rotatably coupled between the guide plates 80a and 80b. The guide sprocket 82 and the tension sprocket 84 engage the chain C in a conventional manner. Accordingly, the additional parts of the chain guide 26 will not be discussed or illustrated in detail herein.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention as used in the normal riding position. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only a selected embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiment according to the present invention are provided for illustration only, and not for the purpose of limiting the invention as defined by the appended claims and their equivalents.

What is claimed is:

1. A bicycle rear derailleur comprising:
a base member including a mounting axle configured to be attached to a bicycle frame;
a movable member including a chain guide;
a linkage assembly coupled between the base member and the movable member to move the chain guide between a retracted position and an extended position; and
an axial spacing adjustment structure disposed on the mounting axle between the base member and the frame, the axial spacing adjustment structure including a removeable first spacer and a second spacer, the first spacer having a first axial side facing the frame and a second axial side configured and arranged to engage the second spacer.

2. The bicycle rear derailleur according to claim 1, wherein
the first axial side of the first spacer has a first frame contact projection extending therefrom, and the second spacer has a second frame contact projection extending therefrom that is exposed in order to contact the frame when the first spacer is removed.

3. The bicycle rear derailleur according to claim 2, wherein
the second frame contact projection has a shape substantially identical to the first frame contact projection as viewed along a center axis of the axle with the first and second spacers disposed thereon.

4. The bicycle rear derailleur according to claim 2, wherein
the second spacer includes movement control projection configured and arranged to selectively engage a portion of the base member to control movement thereof.

5. The bicycle rear derailleur according to claim 2, wherein
the first spacer includes a cutout formed in the second axial side that is configured and arranged to receive the second frame contact projection therein when the first spacer is disposed on the mounting axle.

6. The bicycle rear derailleur according to claim 1, wherein
the second spacer includes movement control projection configured and arranged to selectively engage a portion of the base member to control movement thereof.

7. The bicycle rear derailleur according to claim 6, wherein
the base member includes an axially facing surface with a recess formed therein, and the movement control projection is received in the recess.

8. The bicycle rear derailleur according to claim 7, wherein
the base member includes an adjustment screw threadedly coupled thereto that is configured and arranged to selectively engage the movement control projection.

9. The bicycle rear derailleur according to claim 8, wherein
the base member includes a bumper element arranged between the adjustment screw and the movement control projection.

10. The bicycle rear derailleur according to claim 9, wherein
the base member is not rotationally biased relative to the frame by a biasing member.

11. The bicycle rear derailleur according to claim 6, wherein
the base member includes an adjustment screw threadedly coupled thereto that is configured and arranged to selectively engage the movement control projection of the second spacer.

12. The bicycle rear derailleur according to claim 1, wherein
the base member includes an adjustment screw threadedly coupled thereto that is configured and arranged to selectively engage the second spacer.

13. The bicycle rear derailleur according to claim 1, wherein
the base member is not rotationally biased relative to the frame by a biasing member.

14. The bicycle rear derailleur according to claim 1, wherein
the second axial side of the first spacer is non-rotatably engaged with the second spacer with a protrusion and recess arrangement.

15. The bicycle rear derailleur according to claim 14, wherein
the first spacer includes a mating projection extending from the second axial side that is received in a mating hole of the second spacer in order to non-rotatably engage the second spacer.
